(19) United States
(12) Patent Application Publication
(10) Pub. No.: US 2010/0079890 A1
(43) Pub. Date: Apr. 1, 2010

(54) METHOD AND APPARATUS FOR ENCODING POSITIONING INFORMATION ON A MAGNETIC TAPE MEDIA

(76) Inventor: Robert Allan BRUMMET, Westminster, CO (US)

Correspondence Address: MORRISON & FOERSTER LLP, 755 PAGE MILL RD, PALO ALTO, CA, 94304-1018, US

(21) Appl. No.: 12/239,583

(22) Filed: Sep. 26, 2008

(51) Int. Cl. G11B 20/10

(52) U.S. Cl. 360/40; G9B/20.009

(57) ABSTRACT

Method and apparatus for magnetic tape recording where the magnetic tape has data and servo tracks, and address or other positioning information is encoded on the servo track. A servo track burst pattern is provided whereby certain of the bursts define a gap between the stripes of the first and second half of the burst, each burst including a certain number of the stripes. The presence of the gap in a burst indicates a first binary state, which may be defined as a digital one, and the absence of the gap defines the second binary state, which may be defined as digital value 0. Hence by defining a set of 1s and 0s, longitudinal positioning or address information is encoded on the servo track, thereby improving servo track following of a tape drive.

### FIELD OF THE INVENTION

This invention relates to magnetic tape recording and more particularly to timing based positioning (servo) information recorded on magnetic tape and more particularly to encoding positioning information in the servo information.

Storage subsystems for use with removable media, such as magnetic tape or disc drives, optical tape or disc drives, and the like, are widely used for storing information in digital form. With reference initially to FIG. 1, an exemplary storage subsystem 200 including a magnetic tape drive 202 and removable magnetic tape cartridge 106 is shown. Storage subsystem 200 may include, e.g., a PC server, server class machine, mainframe, desktop computer, or the like. Storage subsystems 200 may include a storage subsystem controller 201 for controlling one or more tape drives 202 contained within the storage subsystem 200 and for controlling other components of the storage subsystem 200.

The storage subsystem 200 may be coupled to a host system 210, which transmits I/O requests to the storage subsystem 100 via a host/storage connection 112. The host system 210 may comprise any computational device known in the art including, for example, a server class machine, a mainframe, a desktop computer, a laptop computer, a hand held computer, or a telephony device.

Tape drive 202 reads and writes data to the primary storage medium, shown in FIG. 1 as a magnetic tape medium 204 contained within a removable magnetic tape cartridge 206. The magnetic tape medium 204 typically comprises a thin film of magnetic material, which stores the data. The tape medium 204 may be moved by the tape drive 202 between a pair of spaced apart reels and past a data transducer to record or read back information. In one type of tape drive system, one of the reels is part of the tape drive 202 while the other reel is part of the removable tape cartridge 206. For this type of tape drive system, the reel which is a part of the tape drive 202 is commonly referred to as a take-up reel, while the reel which is a part of the tape cartridge 206 is commonly referred to as a cartridge reel. Upon insertion of the tape cartridge 206 into the tape drive 202, the magnetic tape medium 204 on the cartridge reel is coupled to the take-up reel of the tape drive 202. Subsequently, prior to removing the tape cartridge 106 from the tape drive 202, the storage tape 204 is rewound onto the cartridge reel and is then uncoupled from the take-up reel.

Tape drive 202 further includes a tape drive controller 203 for controlling, at least in part, data transfer operations. Tape drive controller 203 may further include or access a tape drive memory, which together may analyze and/or store historical event information. Further tape drive controller 203 may include or access logic for displaying the historical event information via a front panel of tape drive 203, as described in greater detail below.

In some tape storage subsystems, the removable tape cartridge 206 is provided with a non-volatile auxiliary memory 208 for storing data in a separate storage medium from the primary storage medium. This data is separate from and in addition to the data stored on the primary storage medium. This auxiliary memory 208 can be, for example, a solid state non-volatile memory such as an electrically erasable programmable read-only memory (EEPROM) or a flash memory which is contained in the housing for the tape cartridge 206. Auxiliary memory 208 may further store historical event information accessible by drive 202 and/or storage subsystem 200.

A position feedback (“servo”) signal when read by a magnetic recording head in such a tape drive from timing data recorded on the magnetic recording tape generates an error signal that describes the relative motion between the head and the Lateral Tape Motion (LTM) in the tape drive. This error signal is commonly referred as the PES (Position Error Signal). Current “LTO” format (Linear Tape Open) magnetic recording tape has embedded magnetic timing stripes that are decoded by LTO tape drives to generate a linear PES signal, which is used to track the LTM that results in correct placement of data tracks on tape as defined by the tape format. (LTO is a family of industry standard formats or specifications in the magnetic tape field.)

LTO specifies a ½ tape width. It is intended for large amounts of data storage. There are typically 384 to 896 tape tracks, and the tape drive has 8 or 16 write elements. The tracks occur in groups, with four data bands interspersed between five servo (positioning) bands. The tape drive read/write heads straddle the two servo bands that border the data band being written or read. Usually the servo tracks are written onto the tape when the LTO tape cartridge is manufactured. The servo mechanism in the tape drive constantly moves the read/write head to keep it on the data track. The head includes special sensors that monitor (read) the servo tracks, to provide the read/write head positioning. LTO tapes are housed in cartridges having a specified form factor.

The LTO format has a series of 18 timing stripes all with ±6 degrees of azimuth angle written in a specific format, having a set of A, B, C and D stripes. The LTO format specifies the accuracy of the servo writing by specifying critical physical dimensions that will result in precise PES decoding to measure RHP (Relative Head Position).

As described in the LTO format specifications, the PES is defined as the ratiometric timing difference between the sets of A, B, C and D stripes as shown below. Since the format defines the A to C and C to A distance as 100 μm±0.25 μm over 7.2 mm of longitudinal distance, this uncertainty results in a calculation error which limits the performance of the tape drive's servo tracking system.

LTO drives and tape are typically used for recording backup data in computer systems, but not so limited. There are several versions of the LTO standard. The cartridge which houses the tape also has a particular form factor defined by the standard. Various current LTO standards are referred to as LTO-1 through LTO-5. LTO in one version specifies four wide data bands sandwiched between five narrow servo bands or tracks, as referred to above. The data bands are numbered 3, 1, 0, 2 across the tape, and are recorded individually in numeric order. The head unit straddles the two servo bands that border the data band that is being written or read. The servo bands (tracks) are used as explained above to keep the head assembly precisely aligned with the data band currently being read or written to. Typically the magnetic servo tracks are written on the tape in the factory, when the tape cartridge is manufactured. Note that the above information pertaining to LTO is merely illustrative. The present invention is not limited to the LTO or any other particular magnetic tape recording standard, but is useful in conjunction therewith in certain embodiments.

Albrecht et al. U.S. Pat. No. 5,930,065, incorporated herein by reference in its entirety, discloses in magnetic tape recording that a way to maximize recording capacity is to maximize the number of parallel tracks on the magnetic tape. The typical way of maximizing the number of tracks is to employ servo systems, also known as positioning systems, which provide track following and allow the tracks to be spaced closely. An example of track following is provision of groups of pre-recorded parallel longitudinal servo tracks that lie between groups of longitudinal data tracks carrying the recorded data so that one or more servo heads (magnetic recording read heads) may read the servo information. An accompanying track following servo subsystem adjusts the lateral position of the magnetic head (or of the tape) to maintain the servo heads centered over the corresponding servo tracks. Since the servo heads are spaced a well defined distance from the respective data read/write magnetic heads, centering of the servo heads results in the data heads being centered over the respective data tracks.

The servo patterns are, like other data recorded on a magnetic tape, a set of magnetic flux transitions recorded on the tape. The servo patterns are typically recorded at non-parallel angles such that the timing of the servo transitions read from the servo pattern at any point on the pattern varies continuously as the servo head is moved across the width of the servo pattern. For instance, a pattern may include straight transitions essentially perpendicular to the length of the track alternating with sloped or slanted transitions. Thus, the relative timing of transitions read by a servo read head varies linearly depending on the lateral position of the servo read head.

Although determination of the lateral position of a head with respect to the width (latitude) of a tape may be readily accomplished by such servo systems, generally there has not been a good way of determining longitudinal (length) position of the tape relative to the read/write heads. Rough estimates of longitudinal position of a tape may be made by counting the number of rotations of an idle guide wheel or of a motor or reel of the tape drive. More accurate longitudinal position information relative to data records may be based on detection of the actual data records. These methods are generally not a 100% successful.

Hence Albrecht discloses superimposing servo longitudinal data information on the servo tracks. This longitudinal data information includes, e.g., longitudinal addressing or tachometer information. The Albrecht servo information is recorded in magnetic flux transition patterns defining at least one longitudinal servo track. A servo burst pattern of at least two repeated pairs of non-parallel magnetic flux transitions is provided at least one of which transitions of each pair is slanted or otherwise continuously longitudinally variable across the width of the servo track. Moreover, at least two transitions of the repeated pairs are shifted longitudinally with respect to other of the transitions of the repeated pairs, the shifted transitions comprising the superimposed addressing data information.

To better understand this, present FIG. 2, identical to FIG. 2 of Albrecht, shows a timing based servo system 10 as used in tape drive 202 of FIG. 1 and that reads a magnetic tape servo pattern and reads data superimposed in the servo pattern. System 10 is typically part of a conventional magnetic tape drive 201 that accepts a tape cartridge 206 (not shown in FIG. 2) and is connected to a host processor 210 (not shown in FIG. 2). The tape cartridge 206 conventionally is a housing containing a length of magnetic tape 20 in FIG. 2, only a short length of which is shown for purposes of simplicity. Such tape drives typically include drive motors for rotating the wheels of the cartridge to move the tape 20 across a head assembly 24, not shown in detail. Head assembly 24 includes a relatively narrow servo read head 26 that detects a servo pattern recorded in a servo track 27 of the tape 20. A data head 28 of the head assembly is typically larger than the servo head and is positioned over a data track region 29 of the tape containing multiple data tracks (not shown) for reading data recorded in a data track or for writing data in a data track.

For simplicity, FIG. 2 shows only a single servo read head and single data head. Most tape systems have multiple parallel servo tracks, multiple servo read heads, and multiple data read and write heads, all of which are conventional. The servo track centerline 30 is indicated as extending along the length of tape 20. Servo read head 26 is relatively narrow and has a width substantially less than the width of the servo track 27. The tape 20 is moved longitudinally across the tape head assembly 24 so that the servo track 27 is moved linearly with respect to the servo head 26. When such movement occurs, the servo pattern magnetic flux transitions are detected by the servo read head 26 to generate an analog servo read head signal that is provided via a servo signal line 34 to a signal decoder 36. Signal decoder 36 processes the servo read head signal and generates a position signal is transmitted via position signal line 38 to a servo controller 40. Servo controller 40 generates a servo control signal and provides it on control line 42 to a servo positioning mechanism, which is part of head assembly 24. The servo positioning mechanism (not shown) responds to the control signal from the servo controller 40 by moving the assembly, including servo head 26 laterally with respect to the servo track centerline 30 to reach the desired servo track or to maintain the servo head 26 center with respect to the servo track centerline 30.

FIG. 4 illustrates somewhat similarly to what is shown in FIG. 2 a portion of a servo track which is conventional, that is not including the shifted flux transitions of the servo track of Albrecht. In this case, the servo track 27 defines a centerline 30, the same as in FIG. 2. Here the servo patterns are depicted as sets of slanted lines, also referred to as “stripes” and which are in a physical sense magnetic flux transitions recorded on the tape. In this case according to the above described well known LTO tape standards, these flux transitions for the servo track are organized in bursts, referred to as bursts A, B, C, and D.

In FIG. 4, each servo burst includes four or five stripes. Each stripe in fact is defined by two (one positive and one negative) magnetic flux transitions. In this case bursts A and B each have five stripes, whereas bursts C and D only have four stripes. As shown, the stripes lie at an angle to a hypothetical line perpendicular to servo track centerline 30. This deviation from the perpendicular is referred to as the azimuth angle and is defined in the appropriate tape standard. As shown, the tape is in this case divided into frames F, each frame length being approximately 200 micrometers long. Hence FIG. 3 shows a conventional LTO type servo track.

In Albrecht as described above, longitudinal positioning data is encoded into the servo bursts. In order to encode the information, two stripes in a burst are shifted longitudinally (longitudinal here refers to the direction of tape travel as indicated by the servo track centerline 30) with respect to other of the stripes in that burst. The shifting defines the superimposed addressing data, see Albrecht FIG. 5. Briefly, in order to encode a digital data bit indicated by 1, one shifts the second stripe in either the A burst or the B burst to the left by 0.25 micrometers. One also shifts the fourth stripe in the A burst or the B burst to the right 0.25 micrometers. The shifted stripes are indicated by the diamond patterns in present FIG. 4. (This shifting of course is compared to their nominal positions.)

Similarly to encode a digital value 0, Albrecht shifts the second stripe in the A burst or B burst to the right 0.25 micrometers and shifts the fourth stripe in the A burst or the B burst to the left 0.25 millimeters. In either case, this opens up gaps in terms of the nominal spacing of the stripes in a burst and these gaps define the digital data states 1, as indicated above. Note the selection of the A and B bursts here is arbitrary.

This approach has significant drawbacks as recognized by the present inventor. If the stripes are placed closer together than their nominal spacing, the maximum linear density of the servo patterns is the new minimum distance between any two adjacent stripes. For instance in the LTO standard, typical spacing between stripes is 5×10⁻⁶ meters. But given the above shifting in Albrecht, the minimum distance between any two stripes is only 4.75×10⁻⁶ meters for the encoded data. This places a limit on the maximum linear density that can be realized with a given servo pattern. It also may cause what is referred to as inter-symbol interference (ISI) in the individual stripes on the tape, in other words making it harder to read such data. It is expected that future tape drives will have increased linear density of the servo pattern. In that case, the Albrecht approach of FIG. 4 becomes even less useful.

### SUMMARY

In accordance with the present invention, a system and method for carrying encoded data indicating longitudinal information on a magnetic tape using the servo pattern are provided which differ from and improve upon that referred to above. In the present encoding scheme, servo stripe shifting is also used. However in this case the shifting of the stripes occurs in, e.g., “even” bursts C and/or D. Moreover those stripes are shifted so that the stripes are never any closer than the nominal stripe spacing defined by the overall servo pattern. This reduces the ISI problem. In this case the shifting is in the C and D bursts, which in this case contain an even number (four) of stripes as shown in FIG. 4. The gap between stripes in the center of the burst due to the shifting, in one embodiment, is less than or equal to two times the stripe spacing as defined by the overall (nominal) density of the servo pattern. Of course, this gap increases the duration of the burst by an equal amount. Another way to express this is that the first, second and third stripes of a C or D burst are shifted away from the burst center by an amount less than or equal to the nominal stripe spacing, and similarly the fourth, fifth and sixth stripes in that burst are shifted away from the burst center (in the opposite direction) by the same amount. Hence the overall burst length is increased by the total of the two (opposing) shifts. However the shift in any case is only used to indicate the 1 bit. The absence of any shift indicates a zero bit (or vice versa).

This approach has several advantages. First, the minimum gap between stripes to encode data is always increased, to ensure ease of detection. Since the servo pattern is made up of bursts that contain either odd (long burst) or even (short burst) numbers of stripes, by using only the even bursts to carry data, one can make the gap equal to the width of two stripes without increasing the length of the burst (compared to the odd bursts) on the tape in the longitudinal direction. Hence stripes are never moved closer together (shifted) for encoding purposes, but only moved (shifted) apart. Moreover by shifting both halves of any particular burst in opposite directions, any two adjacent stripes in the burst can be used to detect the encoded bit.

To put this another way, the so-called even bursts, that is the bursts having an even number of stripes such as bursts C and D in FIG. 4, are effectively split in half and each half is shifted away from the other to encode the first digital value, such that the resulting gap in the center of the burst is LESS THAN OR equal to two times the stripe spacing defined by the overall linear density of the servo pattern. Thus the longitudinal length on the tape of these even bursts carrying the data, even with the shifted stripes, is LESS THAN OR EQUAL TO the length of the A and B (odd) bursts. Of course this is because the A and B odd bursts here have five stripes versus four. Further, detection of the stripes is relatively easy since instead of only detecting the gap, one can detect the encoded data by observing the relative locations of any combination of two stripes where the first stripe is taken from the first half of the burst, and the second stripe is taken from the second half of the burst. Alternatively, an average of the stripe positions in the two halves can be used to identify the gap.

### BRIEF DESCRIPTION OF THE FIGURES

FIG. 1 shows a storage subsystem in the prior art and in which the present invention may be implemented.

FIG. 2 shows a servo pattern reading system in the prior art.

FIG. 3 shows detail of the FIG. 1 signal decoder 36 in the prior art.

FIG. 4 shows a method of encoding longitudinal position information on a servo track in the prior art.

FIGS. 5A and 5B show in the accordance with the invention encoding data referring to longitudinal positioning on a servo track.

FIG. 6 shows a servo writer in the prior art and in which the present invention can be implemented.

### DETAILED DESCRIPTION

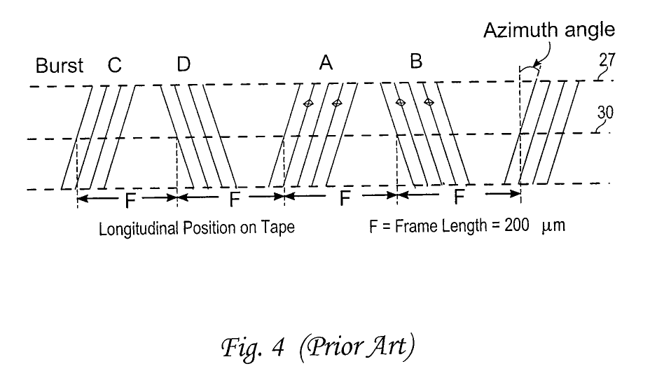

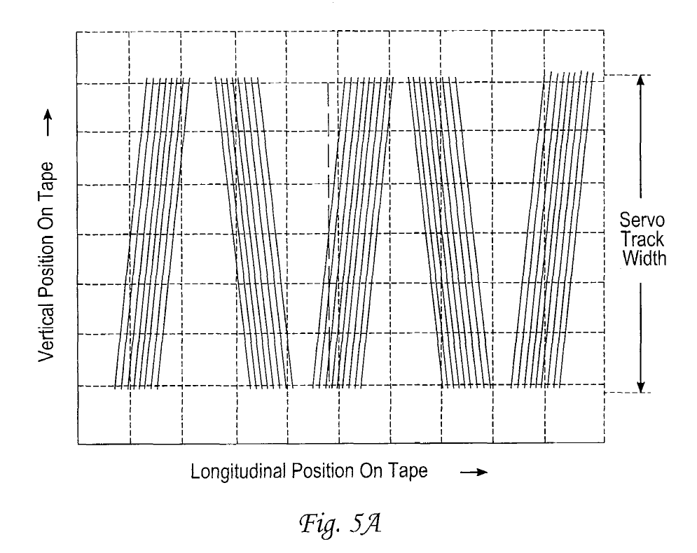

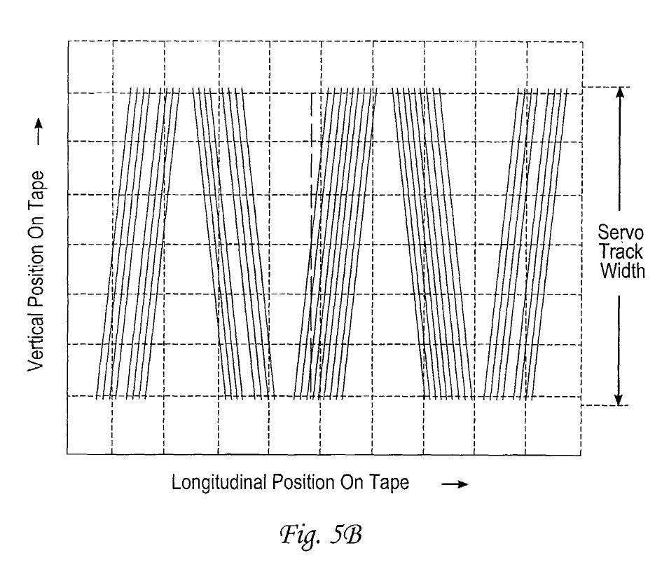

FIG. 5A shows how in accordance with the invention longitudinal position information is encoded on a servo pattern. In this case, the bursts are designated (as in FIG. 4), A, B, C, and D. FIG. 5A shows encoding a first digital state (e.g., binary value 0), which as indicated above, includes no shift in any stripes. Hence, in FIG. 5A all the stripes in the C and D bursts (the only bursts of interest here) are in their nominal position. In this case, the C bursts have an even number of stripes (eight), as do the D bursts. The A bursts have an odd number of stripes, equal to the even number of stripes plus one (nine), as do the B bursts. The particular number of stripes is not limiting since various tape standards typically specify different numbers of stripes depending on the standard in the servo tracks. Here, FIG. 5A shows that some bursts have an even number of stripes, which are the C and D bursts, and the other bursts have odd numbers of stripes, which are the A and B bursts. Note that moreover the stripes can have different shapes. While they are shown as being straight lines at an azimuth angle from the vertical here (per the LTO standard), they could adopt the diamond or chevron shapes typical in the field. Moreover in FIG. 5A, the servo pattern is imposed purely for purposes of illustration on a grid. The tape movement is in the longitudinal direction. Thus FIG. 5A shows the “no shift in any stripes” state which is pointed out above indicates in one embodiment encoding a 0 in terms of position information.

In contrast, FIG. 5B shows the other digital data (binary) state in accordance with the invention which encodes in one embodiment the digital value 1 in terms of position information by shifting each half of certain bursts away from the burst center. In this case, the “even” bursts C and D are subject to the shifting which is more convenient since they have one less stripe then do the A and B bursts. As indicated in FIG. 5B, the shifting causes a gap in the center of certain of the C and D bursts. In this case the C and D bursts do carry the digital value 1. The A and B bursts have their stripes in the nominal position since having an odd number of stripes, one does not apply the shifting to these bursts and they are not used to encode data. This is because the even bursts having one less stripe may have the shift applied to them without increasing the overall width of any particular burst to be any greater than that of an A or B burst. This limits the overall length (duration) of even the shifted bursts to the nominal burst length of the (longer) “odd” A and B bursts in this embodiment.

Hence as pointed out above, by using the even bursts to carry the encoded 1 or 0 digital data values, one can make the gap in these separated or shifted bursts equal to the width of two stripes without increasing the length of the burst on the tape compared to that of a (long) A or B burst. Also with regard to the shifted bursts, the stripes are never moved closer together unlike Albrecht, but only moved apart. This reduces the effects of ISI. Moreover since all the stripes in each shifted burst are actually moved from their nominal positions, any two stripes in a burst, one taken from the first half of the burst and one taken from the second half of the burst, may be used to detect the encoded bit (or its absence). This is not the case with Albrecht.

In Albrecht, no matter how many stripes are in the bursts, there are only two chances of detecting the change in spacing between the relative stripe shifts, i.e. for the 4455 pattern the distance between the second and fourth stripes of burst A or B will signify a one or zero. With the present encoding scheme, if (N=number of stripes in the even burst) one has N chances to detect the encoded bit. As example, if there are six stripes in the even burst, one has three chances in each C or D burst to detect the encoded bit. Hence the present approach also provides more reliable bit detection.

For an LTO format tape an exemplary amount of the actual stripe shift in terms of longitudinal direction, in other words the gap width, is approximately 5×10⁻⁶ meters. This is not limiting.

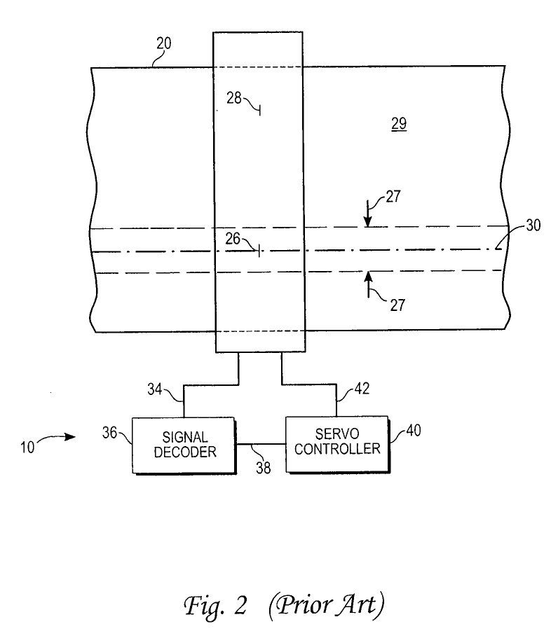

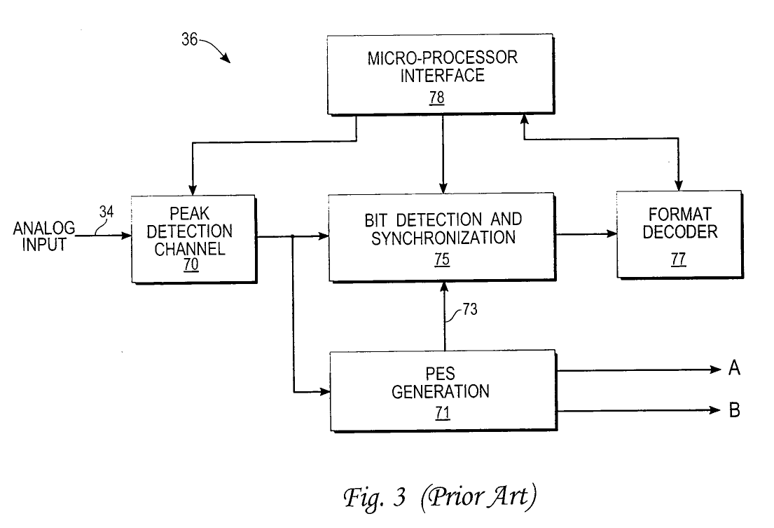

The tape drive servo system to read the servo patterns of FIGS. 5A and 5B would be very similar to that shown in FIG. 2 using signal decoder 36 in a servo reader 10. Present FIG. 3 is the same as FIG. 11 of Albrecht, and shows the signal decoder 36 of FIG. 2 in a block diagram in more detail. Hence, this is a data decoding system or decoder. The analog output signal from the servo head is provided on input line 34 from FIG. 2 to peak detection channel 70, which provides output signals of the position and negative peaks of the servo transitions to servo position error signal (PES) generation circuit 71. PES circuitry 71 also provides signals indicating the various gaps between the stripes. PES circuit 71 counts the stripes to establish the longitudinal position of the servo head with respect to the stripes and provides one of four signals at each gap. The signals indicate the number of stripes counted and whether they are typically chevrons or diamond patterns, which are variance of the stripes. The resulting output signals are provided on line 73 to bit detection and synchronization logic 75.

The output signals of peak detection channel 70 are also supplied to bit detection and synchronization logic 75, which decodes the detected positive peaks of the stripe transitions based on the intervals between the peaks to decode the encoded data bits. The resulting bits as detected are supplied to format decoder 77 to be formatted into digital words and the result in data streams supplied to the tape drive controller microprocessor (not shown) over interface 78. Note that this merely illustrative of a particular type of data decoder.

The only modification to the FIG. 3 apparatus to carry out the present method would be in the bit detection and synchronization logic 75, since instead of detecting the type of gap shown in Albrecht in FIG. 4, one instead detects the type of gap shown in FIG. 5B. Moreover the detected absence of a gap here would indicate the value 0. Such a modification to the logic for bit detection 75 described in Albrecht would be routine and easily accomplished by one of ordinary skill in the art.

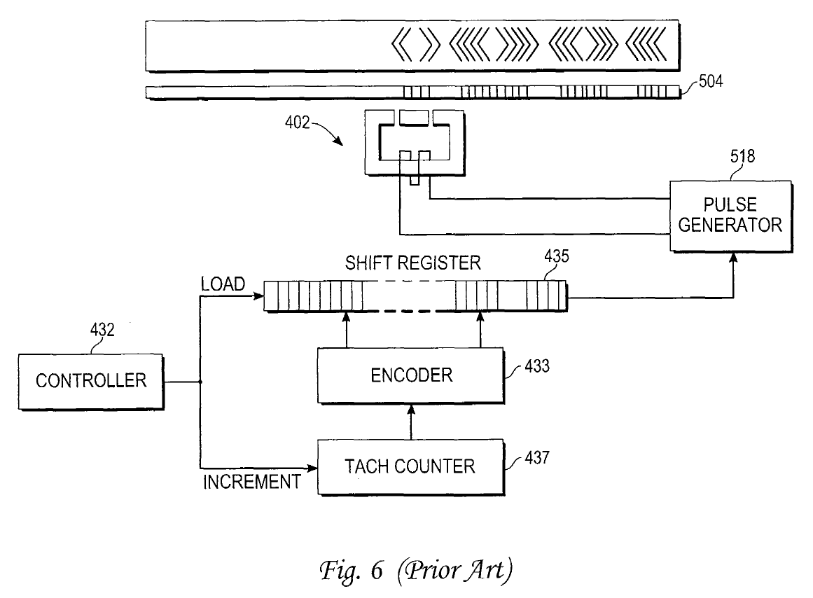

Also needed is a suitable servo writer to write the patterns of FIGS. 5A and 5B. Again, this would be accomplished with routine modifications (in light of this disclosure) to servo writers of the well known type. Present FIG. 6 corresponds to FIG. 28 of Albrecht showing a conventional “writing generator”, also known as a servo writer, for writing servo patterns. Servo write head 402 writes the servo pattern on a tape 504 with the servo pattern itself as illustrated just above 504. In this case the servo patterns are shown as being chevrons rather than straight stripes, but of course this is not limiting. Tape 504 is conventionally moved between the reels (not shown) of a tape drive. Controller 432 and encoder 433 together are a pattern generator. The encoded data, that is the 1s and 0s to be written, is loaded from the encoder 433 to a shift register 435 under control of controller 432 and shifted to pulse generator 518. The shift register 435 represents the timing of the supply of pulses by the pulse generator 518 to cause the write head 402 to write the corresponding flux transitions on tape 402. Thus rather than a regularly repeating stripe pattern, which does not carry any encoded information, the shift register data controls the timing of the pulse generator so as to shift the flux transitions to superimpose the desired encoded data as explained above on the servo pattern. The tachometer counter 437 is incremented by the shift register 435 and supplied to encoder 433 to track the tape position.

In one embodiment, the I/O binary data encoded in the servo bursts conforms to what is referred to in the field as LPOS words (numbers), each word spanning 36 servo frames with one binary digit per servo frame. The LPOS word value increments by one along the length of the tape every 36 servo frames for the full length of the tape. Each LPOS word also includes a sync mark, and is of course 36 bits long. This is merely illustrative.

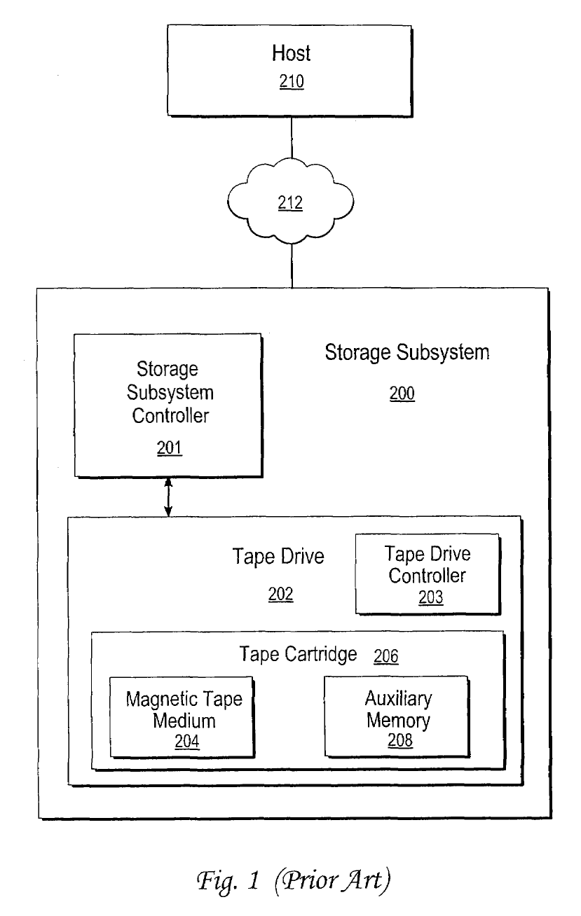

The storage system 200 of FIG. 1, which includes magnetic tape drive 202, is readily modified to include the present servo reader for reading the servo patterns on magnetic tape medium 204 in accordance with this invention as described above.

This disclosure is illustrative and not limiting. Further modifications and improvements will be apparent to those skilled in the art in light of this disclosure and are intended to fall within the scope of the appended claims.

1. A method for writing positioning information on a servo track of a magnetic tape media, comprising the acts of:
encoding the positioning information into binary form;
providing a servo pattern including a plurality of bursts, each burst including a plurality of spaced apart stripes;
modulating the encoded positioning information onto the bursts, wherein a first binary state is defined as each stripe in a burst having approximately equal spacing on the magnetic tape media, and a second binary state is defined as there being a first distance between two of the stripes in a burst and a second greater distance between two other stripes in that burst; and
writing the modulated bursts onto the servo track as a pattern of flux transitions.

2. The method of claim 1, wherein some of the bursts have an odd number of stripes and others have an even number of stripes, wherein the modulating is only of bursts having an even number of stripes.

3. The method of claim 1, wherein the second greater distance is at a center of the burst.

4. The method of claim 1, wherein the servo pattern conforms to an LTO standard, and the bursts having an even number of stripes are C and D bursts.

5. The method of claim 1, wherein the bursts which define the first binary state have about the same duration as the bursts which define the second binary state.

6. The method of claim 1, wherein the second distance is about equal to or less than twice the first distance.

7. The method of claim 1, wherein the second distance is about equal to twice a nominal spacing between adjacent stripes.

8. The method of claim 1, further comprising writing a plurality of additional servo tracks on the magnetic tape media.

9. The method of claim 1, wherein the magnetic tape media is in a housing.

10. The method of claim 1, wherein each stripe is straight or diamond or chevron shaped.

11. The method of claim 1, wherein each stripe lies at an angle relative to an axis lying perpendicular to the tape edge.

12. The method of claim 1, wherein the stripes of adjacent bursts lie at an angle relative to one another.

13. A magnetic tape media carrying a servo track written according to the method of claim 1.

14. A method for reading positioning information from a servo track of a magnetic tape media, comprising the acts of:
positioning a magnetic head over the servo track;
reading a servo pattern from the servo track via the head as a pattern of flux transitions, the servo pattern including a plurality of bursts, each burst including a plurality of spaced apart stripes, wherein the positioning information is encoded into binary form in the servo pattern;
demodulating the encoded positioning information from the bursts, wherein a first binary state is defined as each stripe in a burst having approximately equal spacing on the magnetic tape media, and a second binary state is defined as there being a first distance between two of the stripes in a burst and a second greater distance between two other of the stripes in that burst; and
re-positioning the head over the magnetic tape media longitudinally with respect to a length of the magnetic tape media in accordance with the demodulated positioning information.

15. The method of claim 14, wherein the binary states are determined by one of:
detecting a location of a stripe in a first half of the burst relative to a location of a stripe in a second half of the burst; and
determining an average position of the stripes in a first half of the burst and an average position of the stripes in a second half of the burst.

16. A magnetic tape media having a servo track recorded thereon as a pattern of flux transitions, the servo track including:
a servo pattern including a plurality of bursts, each burst including a plurality of spaced apart stripes;
positioning information in binary form being encoded onto the bursts, wherein a first binary state is defined as each stripe in a burst having approximately equal spacing on the magnetic tape media and a second binary state is defined as there being a first distance between two of the stripes in a burst and a second greater distance between two other of the stripes in that burst.

17. A tape drive for a magnetic tape media, comprising:
a magnetic read/write head;
a drive mechanism for moving a magnetic tape of the magnetic tape media across the head;
a servo system coupled to the head, the servo system coupled to position the head over a servo track of the magnetic tape;
wherein the servo system via the head reads a servo pattern as a pattern of flux transitions from the servo track, the servo pattern including a plurality of bursts, each burst including a plurality of spaced apart stripes, wherein the positioning information is encoded into binary form in the servo pattern; and
the servo system demodulates the encoded positioning information from the bursts, wherein a first binary state is defined as each stripe in a burst having approximately equal spacing on the magnetic tape, and a second binary state is defined as there being a first distance between two of the stripes in a burst and a second greater distance between two other of the stripes in that burst; and
the servo system positions the head over the magnetic tape longitudinally with respect to a length of the magnetic tape in accordance with the demodulated positioning information.

18. The tape drive of claim 17, wherein the binary states are determined by one of:
detecting a location of a stripe in a first half of the burst relative to a location of a stripe in a second half of the burst; and
determining an average position of the stripes in a first half of the burst and an average position of the stripes in a second half of the burst.

19. A servo writer for writing servo information on a servo track of a magnetic tape media, comprising:
a magnetic write head;
a drive mechanism for moving the magnetic tape media along the head; and
a servo write system coupled to the head to write a servo track on the magnetic tape media as a pattern of flux transitions, the servo track including:
a servo pattern including a plurality of bursts, each burst including a plurality of spaced apart stripes; and
positioning information in binary form being encoded onto the bursts, wherein a first binary state is defined as each stripe in a burst having approximately equal spacing on the magnetic tape media and a second binary state is defined as there being a first distance between two of the stripes in a burst and a second greater distance between two other of the stripes in that burst.

20. A storage subsystem comprising:
a storage subsystem controller;
a tape drive for a magnetic tape media coupled to the storage subsystem controller and including:
a magnetic read/write head;
a drive mechanism for moving a magnetic tape of the magnetic tape media across the head;
a servo system coupled to the head, the servo system coupled to position the head over a servo track of the magnetic tape;
wherein the servo system via the head reads a servo pattern as a pattern of flux transitions from the servo track, the servo pattern including a plurality of bursts, each burst including a plurality of spaced apart stripes, wherein the positioning information is encoded into binary form in the servo pattern; and
the servo system demodulates the encoded positioning information from the bursts, wherein a first binary state is defined as each stripe in a burst having approximately equal spacing on the magnetic tape, and a second binary state is defined as there being a first distance between two of the stripes in a burst and a second greater distance between two other of the stripes in that burst; and
the servo system positions the head over the magnetic tape longitudinally with respect to a length of the magnetic tape in accordance with the demodulated positioning information.
